(19) United States
(12) Patent Application Publication
(10) Pub. No.: US 2007/0177914 A1
(43) Pub. Date: Aug. 2, 2007

(54) WET ELECTROPHOTOGRAPHIC APPARATUS

(75) Inventors: Motohiro MASEKI, Saitama (JP); Masatoshi TAKANO, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/668,722

(22) Filed: Jan. 30, 2007

(30) Foreign Application Priority Data
Feb. 2, 2006 (JP) 2006-025204

(51) Int. Cl. G03G 21/00

(52) U.S. Cl. 399/348

(57) ABSTRACT

A wet electrophotographic apparatus includes an intermediate transcriptional unit that includes a rubber member on a surface thereof, the intermediate transcriptional unit being configured to transcribe a toner image formed by toner held on a surface of the rubber member onto a printed subject, a cleaning solution applying unit configured to apply cleaning solution to the surface of the rubber member after transcribing the toner image onto the printed subject, and a toner removing unit configured to have a higher stiffness than that of the rubber member and to be in contact with the rubber member under a predetermined pressure so as to remove residual toner, which is left on the intermediate transcriptional unit even after transcribing the toner image onto the printed subject, with the cleaning solution.

### BACKGROUND OF THE INVENTION

The present invention relates to a wet electrophotographic apparatus provided with an intermediate transcriptional body configured to transcribe a toner image held on a surface thereof onto a printed subject.

There is known a wet electrophotographic apparatus in which liquid developer (with toner and carrier solution) is employed. In the wet electrophotographic apparatus, an electrostatic latent image is formed on a photoconductive drum with a laser beam exposing a surface of the photoconductive drum. Then, the toner included in the liquid developer is transferred onto the surface of the photoconductive drum to form a toner image corresponding to the electrostatic latent image on the surface of the photoconductive drum. Thereafter, the toner image is transferred onto an intermediate transcriptional body so as to transfer the toner image from the intermediate body to a printed subject such as a recording paper (that is, so as to print the toner image on a printed subject).

In the aforementioned wet electrophotographic apparatus, in the operation of transferring the toner image from the intermediate transcriptional body onto the printed subject, it is difficult to transfer 100% of the toner onto the printed subject, and even after the transferring operation, a slight amount of toner is left on the intermediate transcriptional body. The residual toner causes a low quality of image formed on the printed subject such as a ghost that would appear on an image to be printed thereafter, and photographic fog that would appear on a background portion.

Conventionally, a cleaning blade or a cleaning roll has been employed as a means for cleaning the residual toner on the intermediate transcriptional body. The cleaning blade or the cleaning roll, which is arranged to be in contact with a surface of the intermediate transcriptional body after the operation of transferring the toner image to the printed subject, has a function of wiping off or scraping off the residual toner.

In addition, for instance, there is disclosed in Japanese Patent Provisional Publication No. HEI 7-28342 (hereinafter, simply referred to as '342 Publication) an image forming method having a feature that, in a process of transferring a liquid toner image formed on a surface of an image carrier to a final printed subject after transferring it to an intermediate transcriptional body whose surface is covered with a silicon compound, a cleaning operation of cleaning the intermediate transcriptional body is performed with a member impregnated with organic solvent which is a component of the liquid toner. According to the image forming method, a slight amount of residual toner is wiped off with the cleaning member for cleaning the intermediate transcriptional body. For example, the cleaning member is a sheet impregnated with the organic solvent as a component of the liquid toner. In the image forming method, the residual toner is cleaned through a synergistic effect of the heated intermediate transcriptional body and the organic solvent contained in the cleaning member, and a preferred image is constantly formed even in a long-time continuous operation.

However, the residual toner is not completely removed in the aforementioned cleaning method using the cleaning blade or cleaning roll. One of reasons why it is difficult to completely remove the residual toner is a surface layer of the intermediate transcriptional body made from rubber material. For example, even though the surface layer made from the rubber material is formed such that surface roughness thereof is approximately 1 μm or less, when an average particle size of the toner is about 2 μm, a toner particle with a particle size smaller than 1 μm, which can be present in accordance with a particle size distribution of the toner, can enter into a recessed portion according to the surface roughness of the intermediate transcriptional body.

Namely, when the recessed portion of the intermediate transcriptional body is deep, the cleaning blade might not enter into a back of the recessed portion or thereby directly contact with the toner in the back of the recessed portion. Therefore, the cleaning blade cannot scrape off the toner adhered in the back of the recessed portion. Meanwhile, the cleaning roll performs the cleaning operation with two functions of mechanically scraping off the toner as the blade and electrostatically attracting the toner with the cleaning roll to which a bias with a polarity opposite to the toner is applied. However, the toner cannot sufficiently be removed in the case where the recessed portion is so deep that the cleaning roll cannot contact with the toner therein.

Further, in the image forming method described in the '342 Publication, an efficiency of removing the residual toner is considered to be improved compared with a method without using the organic solvent, as the organic solvent (cleaning liquid) is used and concurrently the intermediate transcriptional body is heated. However, since a mechanism for heating the intermediate transcriptional body is required, a configuration provided with the heating mechanism is complicated. Additionally, in the '342 Publication, the organic solvent has to continuously be supplied for the long-time continuous operation. However, a specific configuration for supplying the organic solvent is not disclosed.

### SUMMARY OF THE INVENTION

The present invention is advantageous in that there can be provided an improved wet electrophotographic apparatus, with a simpler configuration than that of a conventional apparatus, which can prevent a ghost and photographic fog on a background portion caused by an intermediate transcriptional body to improve the quality of an image generated thereby.

According to an aspect of the present invention, there is provided a wet electrophotographic apparatus, which includes an intermediate transcriptional unit that includes a rubber member on a surface thereof, the intermediate transcriptional unit being configured to transcribe a toner image formed by toner held on a surface of the rubber member onto a printed subject, a cleaning solution applying unit configured to apply cleaning solution to the surface of the rubber member after transcribing the toner image onto the printed subject, and a toner removing unit configured to have a higher stiffness than that of the rubber member and to be in contact with the rubber member under a predetermined pressure so as to remove residual toner, which is left on the intermediate transcriptional unit even after transcribing the toner image onto the printed subject, with the cleaning solution.

Optionally, the toner removing unit may be formed from rubber with a rubber hardness of 60° to 80°.

Optionally, the rubber member included in the intermediate transcriptional unit may be configured to have a JIS K6253 hardness of 20 to 60.

Optionally, the rubber member included in the intermediate transcriptional unit may be configured to have a surface roughness of 1 μm to 5 μm in a value of ten-point height of irregularities.

Optionally, the toner removing unit may be configured as a plate blade that mechanically scrapes the residual toner away from the intermediate transcriptional unit.

Alternatively or optionally, the toner removing unit may be configured as a cleaning roller, to which a predetermined bias voltage with a polarity opposite to the toner is applied, so as to mechanically scrape and electrostatically attract the residual toner away from the intermediate transcriptional unit.

Still optionally, a bias voltage higher than that applied to the intermediate transcriptional unit may be applied to the toner removing unit.

Optionally, the cleaning solution applying unit may be provided with a function of a cleaning roller, to which a predetermined bias voltage with a polarity opposite to the toner is applied, so as to mechanically scrape and electrostatically attract the residual toner away from the intermediate transcriptional unit.

Yet optionally, a bias voltage higher than that applied to the intermediate transcriptional unit may be applied to the cleaning solution applying unit.

Optionally, the cleaning solution may be carrier solution for conveying the toner.

Optionally, the wet electrophotographic apparatus may further include a cleaning solution supplying unit configured to supply carrier solution for conveying the toner as the cleaning solution to the cleaning solution applying unit.

Further optionally, the cleaning solution applying unit may be shaped as a roller that is configured to be rotated around a rotational axis thereof. In this case, the cleaning solution supplying unit may include a cleaning solution conveying mechanism that is configured to be helical and rotated around a rotational axis parallel to the rotational axis of the cleaning solution applying unit so that the cleaning solution can be conveyed along the rotational axis of the cleaning solution applying unit accompanying rotation of the cleaning solution conveying mechanism.

Optionally, the wet electrophotographic apparatus may further include a cleaning solution supplying unit configured to supply waste liquid, ejected from the wet electrophotographic apparatus, which includes carrier solution for conveying the toner, as the cleaning solution to the cleaning solution applying unit.

Still optionally, the wet electrophotographic apparatus may further include a photoconductive drum configured to transcribe the toner image onto the intermediate transcriptional unit. In this case, the cleaning solution supplying unit may be configured to supply waste liquid, ejected from the photoconductive drum after transcribing the toner image onto the intermediate transcriptional unit, as the cleaning solution to the cleaning solution applying unit.

According to another aspect of the present invention, there is provided a wet electrophotographic apparatus, which includes a photoconductive drum configured to electrostatically attract toner onto an electrostatic latent image formed thereon so as to form a toner image corresponding to the latent image, an intermediate transcriptional unit that includes a rubber member on a surface thereof, the toner image being transcribed onto a surface of the rubber member of the intermediate transcriptional unit, the intermediate transcriptional unit being configured to transcribe the toner image on the surface of the rubber member onto a printed subject, a cleaning solution applying unit configured to apply cleaning solution to the surface of the rubber member after transcribing the toner image onto the printed subject, a cleaning solution supplying unit configured to supply waste liquid including carrier solution for conveying the toner, which has been ejected from the photoconductive drum after transcribing the toner image onto the intermediate transcriptional unit, as the cleaning solution to the cleaning solution applying unit, and a toner removing unit configured to have a higher stiffness than that of the rubber member and to be in contact with the rubber member under a predetermined pressure so as to remove residual toner, which is left on the intermediate transcriptional unit even after transcribing the toner image onto the printed subject, with the cleaning solution.

Optionally, a predetermined bias voltage with a polarity opposite to the toner may be applied to the toner removing unit so that the toner removing unit can electrostatically attract the residual toner left on the intermediate transcriptional unit.

### BRIEF DESCRIPTION OF THE ACCOMPANYING DRAWINGS

FIG. 1 schematically shows a configuration of a wet electrophotographic apparatus in a first embodiment according to one or more aspects of the present invention.

FIG. 2 is a perspective view showing a portion of the wet electrophotographic apparatus in the first embodiment according to one or more aspects of the present invention.

FIG. 3 schematically shows a configuration of a carrier solution conveying unit in the first embodiment according to one or more aspects of the present invention.

FIGS. 4A and 4B are illustrations for explaining how residual toner on an intermediate transcriptional roller is scraped by a fourth blade in the first embodiment according to one or more aspects of the present invention.

FIG. 5 schematically shows a portion of a wet electrophotographic apparatus in a second embodiment according to one or more aspects of the present invention.

FIG. 6 schematically shows a portion of a wet electrophotographic apparatus in a third embodiment according to one or more aspects of the present invention.

### DETAILED DESCRIPTION OF THE EMBODIMENTS

Hereinafter, concrete embodiments of a wet electrophotographic apparatus according to the present invention will be explained with reference to the accompanying drawings.

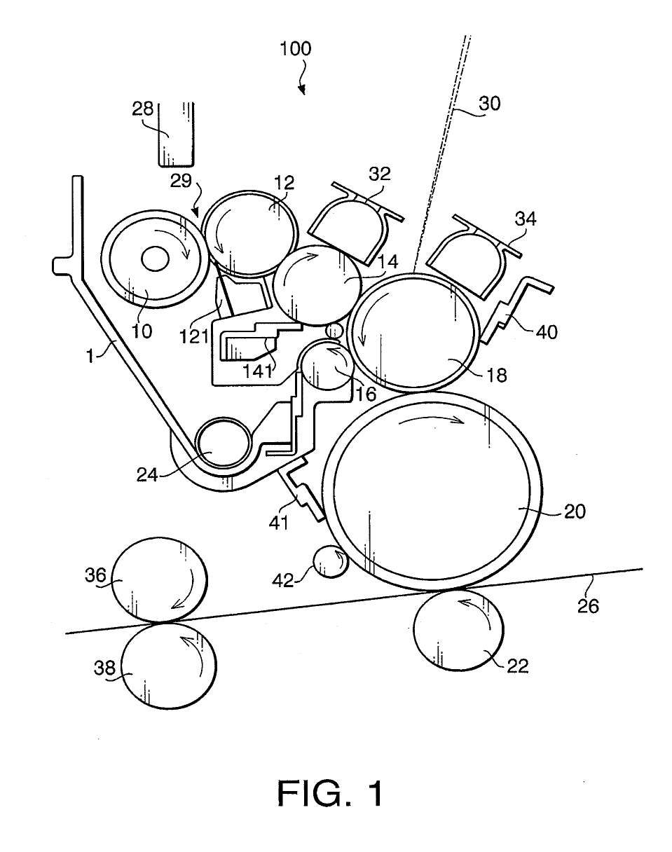

FIG. 1 schematically shows a configuration of a wet electrophotographic apparatus 100 in a first embodiment according to the present invention. The wet electrophotographic apparatus 100 includes a developing portion provided with a first housing 1, supporting roller 10, developer supplying roller 12, developing roller 14, squeeze roller 16, agitating roller 24, developer supplying tube 28, first charging unit 32, first blade 121, and second blade 141, a toner image forming portion provided with a photoconductive drum 18, second charging unit 34, third blade 40, and light source unit (not shown) that emits a laser beam 30, a transcriptional portion provided with an intermediate transcriptional roller 20, secondary transcriptional roller 22, fourth blade 41, and carrier applying roll 42, and a fixing portion provided with fixing rollers 36 and 38.

As shown in FIG. 1, a rotational direction in an image forming operation of each of the holding roller 10, developing roller 14, intermediate transcriptional roller 20, and fixing roller 36 is clockwise. Meanwhile, the rotational direction of each of the developer supplying roller 12, squeeze roller 16, photoconductive drum 18, secondary transcriptional roller 22, fixing roller 38, and carrier applying roll 42 is counterclockwise. It is noted that the rotational direction of the carrier applying roll 42 may be clockwise.

In addition, the holding roller 10, developer supplying roller 12, developing roller 14, and squeeze roller 16 are rotatably supported at a side surface of the first housing 1 such that axes thereof are parallel to each other. In the same manner, the photoconductive drum 18, intermediate transcriptional roller 20, secondary transcriptional roller 22, carrier applying roller 42, and fixing rollers 36 and 38 are supported in a predetermined position in the wet electrophotographic apparatus such that axes thereof are parallel to the axes of each of the rollers included in the developing portion.

The developer supplying tube 28 is arranged above a position near a center between the holding roller 10 and developer supplying roller 12 in a rotational axis direction thereof. The developer supplying tube 28 is configured to supply the developer from a liquid developer source (not shown).

The first and second charging units 32 and 34 are arranged closely above the developing roller 14 and the photoconductive drum 18 (in directions indicated by an hour hand at one or two o'clock with respect to the developing roller 14 and the photoconductive drum 18), respectively.

A traveling direction of the recording paper 26 in a printing operation is a direction from a right hand to a left hand in FIG. 1. The toner is transferred on the recording paper 26 between the intermediate transcriptional roller 20 and the secondary transcriptional roller 22. Thereafter, the recording paper 26 is discharged outside the apparatus via the fixing rollers 36 and 38.

The developer is mixed liquid including the toner and carrier solution, and is prepared at a predetermined concentration (for example, 3:7 in a weight ratio of the toner for the carrier solution) in a developer container (not shown). For instance, petroleum solvent can be employed as the carrier solution. The developer pumped up form the developer container by a pump (not shown) is supplied from the developer supplying tube 28 to and held in a developer holding portion 29 as a V-shaped space formed with being surrounded by an outer circumferential surface of the holding roller 10, an outer circumferential surface of the developer supplying roller 12, and side walls of the first housing 1.

The holding roller 10 is rotated in the clockwise direction, while the developer supplying roller 12 is rotated in the counterclockwise direction. With the developer entering into a gap between the holding roller 10 and the developer supplying roller 12, the developer is applied to the developer supplying roller 12.

The developer supplying roller 12 is formed with a plurality of fine grooves thereon. Each of the grooves has a depth of several microns to several tens of microns, and several hundreds of grooves are formed on the surface of one inch width of the developer supplying roller 12. The grooves on the developer supplying roller 12 can be formed with a surface coating technology widely used in a field of a gravure roll. For example, the grooves are formed at a slant with respect to an axial direction of the developer supplying roller 12. Preferably, the grooves are formed at a slant by 45 degrees with respect to the axial direction. When the developer is sufficiently applied to the developer supplying roller 12, the developer enters into insides of the grooves.

Thereafter, the developer supplying roller 12 to which the developer has been applied is further rotated, and then the developer on the surface thereof is scraped off such that only the developer held in the insides of the grooves is substantially left.

The developer supplying roller 12 is fixed such that the surface thereof slightly presses a surface of the developing roller 14 and is evenly in contact with the surface of the developing roller 14 in the axial direction. Hence, when a surface portion of the developer supplying roller 12 that holds the developer in a groove thereon reaches a contact point with the developing roller 14, the developer is transferred to the developing roller 14, so that a thin layer of the developer with an even thickness corresponding to a depth of the groove is formed on the developing roller 14.

A bias voltage of about +500 V is applied to the developing roller 14, and a corona bias of about +5 kV is applied to a surface layer of the developing roller 14 by the first charging unit 32 arranged so as to extend in a direction of a rotational axis of the developing roller 14. In addition, the second charging unit 34 arranged close to the photoconductive drum 18 extends along a direction of a rotational axis of the photoconductive drum 18, and charges, to about +700 V, an area in the vicinity of the surface of the photoconductive drum 18 rotated in the counterclockwise direction.

The photoconductive drum 18, after being charged by the second charging unit 34, is exposed by the laser beam 30 scanned in the direction of the rotational axis thereof (main scanning direction) based on image forming information. In an area onto which the laser beam has been irradiated, an electrical potential is reduced to about +100 V. Consequently, an electrostatic latent image with a potential contrast between the electrical potentials of +700 V and +100 V is formed on the photoconductive drum 18.

When the photoconductive drum 18 on which the electrostatic latent image is formed is further rotated to be in contact with the thin layer of the developer on the developing roller 14, the carrier solution is adhered to the photoconductive drum 18 such that the toner is attracted and transferred only to the area on the photoconductive drum 18 in which the electrical potential is reduced. Namely, when a surface potential on the developing roller 14 is +500 V and a surface potential of the exposed area on the photoconductive drum 18 is +100 V, the toner (with positive charge) is transferred to the electrostatic latent image by a development electrical field formed by applying a bias of about +500 V to the developing roller 14. Meanwhile, since the toner is not adhered to an area with an electrical potential of +700 V, a toner image corresponding the electrostatic latent image is formed on the photoconductive drum 18 by the toner including the carrier solution.

The squeeze roller 16, which has a function of controlling an amount of the carrier solution adhered to the photoconductive drum 18, is arranged close to the photoconductive drum 18 to be rotated in the counterclockwise direction. Accordingly, in a surface area on the photoconductive drum 18 that has passed through the squeeze roller 16, the toner image is formed by the toner containing a predetermined amount of the carrier solution.

A bias of about −100 V is applied to the intermediate transcriptional roller 20 rotated in the clockwise direction. Therefore, The toner with the positive charge is transferred from the photoconductive drum 18 to the intermediate transcriptional roller 20. Consequently, the toner image is transcribed onto the intermediate transcriptional roller 20.

A bias of about −1 kV is applied to the secondary transcriptional roller 22 rotated in the counterclockwise direction. In a position on the recording paper 26 where the recording paper 26 is sandwiched between the intermediate transcriptional roller 20 and the secondary transcriptional roller 22, the toner on the intermediate transcriptional roller 20 is attracted to the side of the secondary transcriptional roller 22 to be transferred onto the recording paper 26, so that the toner image is transcribed onto the recording paper 26. Thereafter, the toner is fixed on the recording paper 26 with predetermined operations of heating and pressing the recording paper 26 being performed by the fixing rollers 36 and 38.

The agitating roller 24 is provided in the vicinity of a bottom of the first housing 1. There are stored in the vicinity of the bottom of the first housing 1 a portion of the developer that has dropped from the holding roller 10 by gravitation, another portion of the developer that has been scraped by the first blade 121 and the second blade 141 provided to the developer supplying roller 12 and the developing roller 14, respectively, and a portion of the carrier solution that has removed by the squeeze roller 16. The agitating roller 24 is shaped helical, and thereby the stored developer is moved in a predetermined direction with being agitated by the agitating roller 24 being rotated so as to be gathered in the developer container. The developer thus gathered is reused after the concentration of the carrier solution and the toner included therein has been adjusted.

The carrier applying roll 42 is arranged between the secondary transcriptional roller 22 and the fourth blade 41 on a circumferential surface of the intermediate transcriptional roller 20. A surface of the carrier applying roll 42 is formed from a material such as sponge and felt, which can hold the carrier solution and apply the carrier solution to the intermediate transcriptional roller 20. In the embodiment, the carrier applying roll 42 is shaped as a roll. However, it is noted that the carrier applying roll 42 may be shaped as a plate.

The carrier solution included in the developer is an optimum medium as a medium for cleaning to be applied by the carrier applying roll 42 in consideration of that a function of making the toner easily move is required for such a medium as described below. Accordingly, the carrier solution is employed as a medium for cleaning in the embodiment according to the present invention. However, the medium for cleaning is not limited to the carrier solution, and the carrier solution may be replaced with any other medium having the same function and operation.

The fourth blade 41 is in contact with the intermediate transcriptional roller 20 under pressure, and has a function of scraping residual toner on the surface of the intermediate transcriptional roller 20 to which the carrier solution has been applied by the carrier applying roll 42. In addition, the fourth blade 41 is formed, for example, from rubber material that is harder than rubber material on the surface of the intermediate transcriptional roller 20. For instance, a rubber hardness of 60° to 80° is employed for the fourth blade 41.

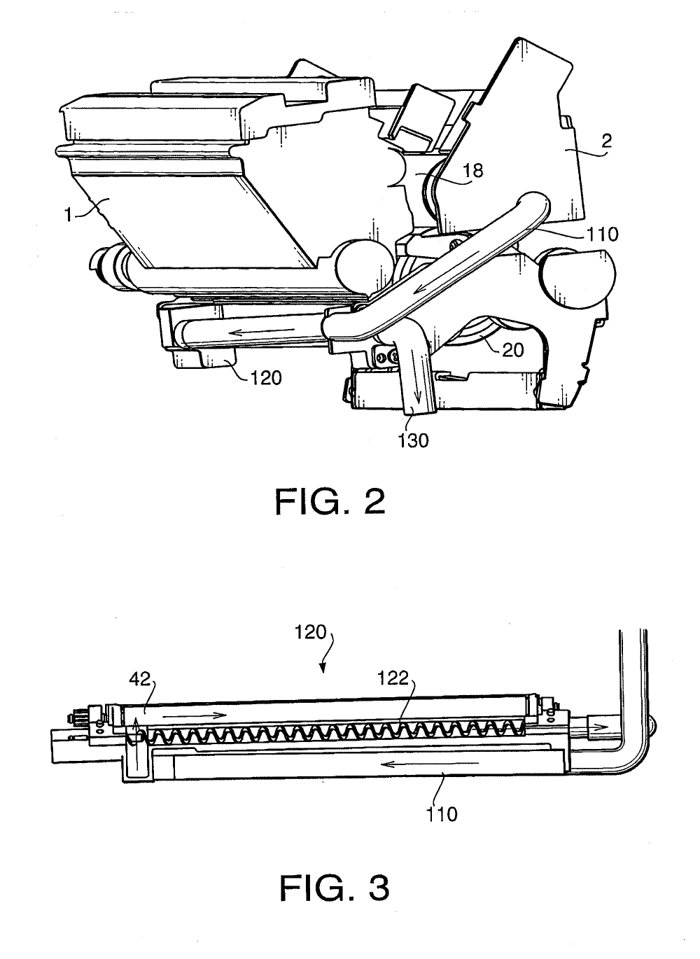

FIG. 2 is a perspective view showing a portion of the wet electrophotographic apparatus 100, which is used for explaining a carrier solution conveying unit 120 configured to supply the carrier solution to the carrier applying roll 42.

A second housing 2 supports the photoconductive drum 18. A conveying pipe 110 provided to extend below the housing 1 from the second housing 2 has a function of conveying waste developer ejected from the photoconductive drum 18. The waste developer is mixed liquid including the toner and the carrier solution scraped from the photoconductive drum 18 by the third blade 40. The waste developer is developer obtained after the toner image has been transcribed to the intermediate transcriptional roller 20, and contains relatively much carrier solution. For this reason, the waste developer is accessible as a medium for cleaning the intermediate transcriptional roller 20. It is noted that the term “carrier solution” hereinafter includes any waste developer contained therein.

The conveying pipe 110 is connected to a carrier solution conveying unit 120 provided below the first housing 1. Further, the carrier solution conveying unit 120 is provided with an ejecting pipe 130 for ejecting the waste developer.

FIG. 3 schematically shows a configuration of the carrier solution conveying unit 120. The carrier solution conveying unit has a carrier solution conveying means 122.

The carrier solution conveying means 122 has a rotational axis parallel to a rotational axis of the carrier applying roll 42, and is shaped helical to have substantially the same length as the carrier applying roll 42 in a direction of the rotational axis thereof. The waste developer is conveyed from a left hand to a right hand in FIG. 3 accompanying rotation of the carrier solution conveying means 122. During that time, since the waste developer is in contact with the carrier applying roll 42, the carrier applying roller 42 absorbs the waste developer. In addition, the carrier solution conveying means 122 has another function of collecting the toner and carrier solution scraped by the fourth blade 41 (see FIG. 1). The collected toner and carrier solution are ejected from the ejecting pipe 130 accompanied by the transfer of the waste developer.

In the embodiment according to the present invention, since the carrier solution conveying unit 120 utilizes the waste developer from the photoconductive drum 18, it is possible to reuse the developer. It means that a separate mechanism for supplying the carrier solution does not have to be provided. However, a mechanism for supplying the carrier solution to the carrier applying roll 42 is not limited to the carrier solution conveying unit 120, and, for example, may be configured to supply only the carrier solution from a container separately provided to hold only the carrier solution. According to such a configuration, it is possible to supply pure carrier solution containing no toner to the carrier applying roll 42.

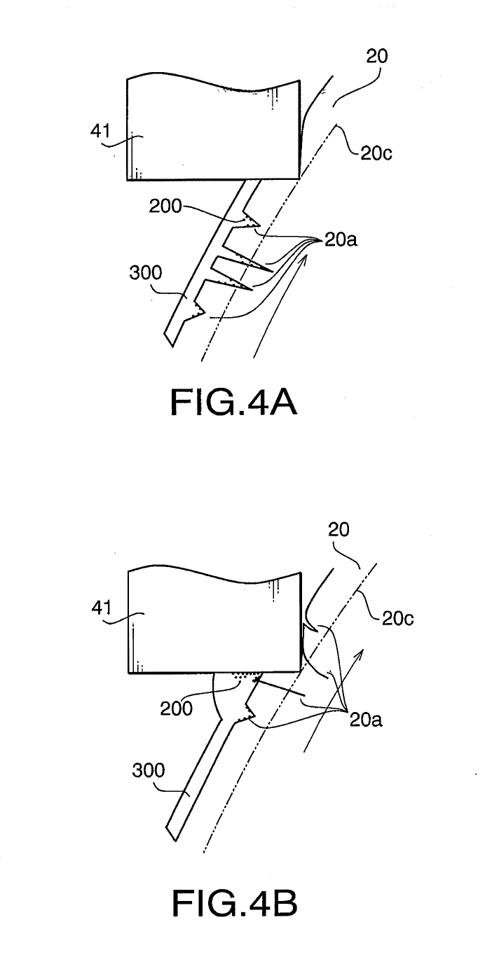

FIG. 4 is an illustration for explaining how the residual toner on the intermediate transcriptional roller 20 is scraped by the fourth blade 41.

The intermediate transcriptional roller 20 has a surface layer formed from a conductive solid rubber with a JIS K6253 hardness of about 20 to 60. There are employed as the conductive solid rubber, for example, urethane rubber, NBR (nitrile rubber), silicon rubber, and epichlorohydrin rubber. In addition, the conductive solid rubber with an electrical resistance of 10⁴Ω to 10¹⁰Ω can be used. Further, the conductive solid rubber with a surface roughness of 1 μm to 5 μm in the value of ten-point height of irregularities can be used. For example, using the conductive solid rubber with a surface roughness of about 5 μm in the value of ten-point height of irregularities can reduce a manufacturing cost of the intermediate transcriptional roller 20 compared with a case of using a conventional conductive solid rubber with a surface roughness of about 1 μm in the value of ten-point height of irregularities.

FIGS. 4A and 4B schematically show a vicinity of a contact portion between the intermediate transcriptional roller 20 and the fourth blade 41. The intermediate transcriptional roller 20 has surface roughness due to fine grooves 20a formed thereon. As shown in FIG. 4A, residual toner 200 is adhered to each of the grooves 20a. The toner located at a top surface of the intermediate transcriptional roller 20 is easily transcribed to the recording paper 26. Meanwhile, the toner located in the grooves 20a is hard to be transcribed to the recording paper 26, and is therefore left adhered to insides of the grooves 20a as the residual toner 200.

The fourth blade 41 is harder than the surface layer of the intermediate transcriptional roller 20. Therefore, the fourth blade 41 breaks into the surface layer of the intermediate transcriptional roller 20 by a predetermined depth. A distal end of the fourth blade 41 passes through the surface layer of the intermediate transcriptional roller 20 so as to trace a trajectory 20c. When the groove 20a is shallow, the distal end of the fourth blade 41 can reach the bottom of the groove 20a. Meanwhile, when the groove 20a is deep, the distal end of the fourth blade 41 cannot reach the bottom of the groove 20a.

Carrier solution 300 applied by the carrier applying roller 42 is held on the surface of the intermediate transcriptional roller 20 by a predetermined thickness, and enters into the grooves 20a. The carrier solution 300 contacts with the residual toner 200 within the grooves 20a. An attractive force is previously applied to the residual toner 200 between the intermediate transcriptional roller 20 and the secondary transcriptional roller 22 such that the residual toner 200 is attracted to the side of the secondary transcriptional roller 22. Thereby, the residual toner 200 is in a state where it can easily be removed from the intermediate transcriptional roller 20. When the carrier solution 300 contacts with the residual toner 200, the residual toner 200 gets into a state where it can further easily be removed from the grooves 20a. Consequently, a portion of the residual toner 200 is removed to float in the carrier solution 300.

FIG. 4B schematically shows an operation where the residual toner 200 within the grooves 20a is scraped. Accompanying the rotation of the intermediate transcriptional roller 20, the groves 20a are crashed by a pressure from the fourth blade 41 when the fourth blade 41 passes through the grooves 20a. When the groove 20a is crashed, a volume of the groove 20a is reduced, so that the carrier solution 300 and the residual toner 200 in the carrier solution 300 are squeezed and pushed out (hereinafter, this phenomenon is referred to as a “squeeze effect”). Accordingly, in an area on the intermediate transcriptional roller 20 through which the fourth blade 41 has passed, the carrier solution 300 and the residual toner 200 are removed.

So far, when there is a groove deeper than the trajectory 20c of the distal end of the fourth blade 41, since the fourth blade 41 cannot reach the bottom of the groove, it has been difficult to mechanically and directly scrape the residual toner 200. However, in the embodiment according to the present invention, the carrier solution 300, which enters into the groove 20a, makes it easy to remove the residual toner 200 from the inside of the groove. Further, by the squeeze effect, it is possible to remove the residual toner 200 in a position that the fourth blade 41 cannot reach.

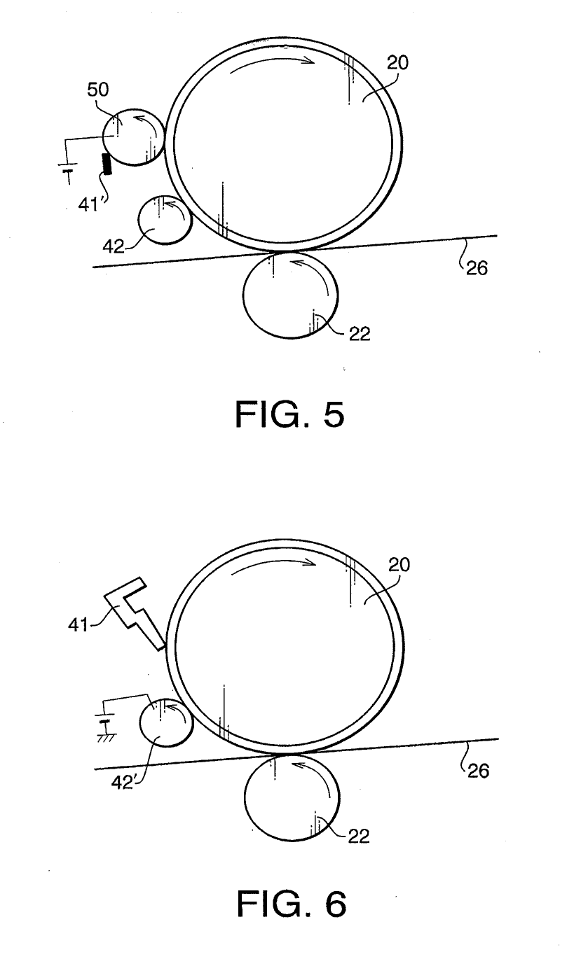

FIG. 5 is a drawing for explaining a second embodiment according to the present invention. In the second embodiment, a cleaning operation is performed using a cleaning roll 50 as substitute for the fourth blade 41.

The cleaning roll 50 is arranged in the same position as the fourth blade 41 around the intermediate transcriptional roller 20. The cleaning roll 50 is arranged such that a rotational axis thereof is parallel to that of the intermediate transcriptional roller 20, and such that a circumferential surface thereof is in contact with the intermediate transcriptional roller 20 under pressure. The cleaning roll 50 is formed with a roller made of SUS or the like being coated with PFA (perfluoroalkoxy polymer resin). A cleaning roller with an electrical resistance of 10⁸-10¹¹ Ω is usable as the cleaning roll 50. In addition, the cleaning roll 50 is used with a bias with a polarity opposite to the toner being applied thereto. Such a cleaning bias makes it possible to electrostatically attract the residual toner. It is noted that since a bias with a polarity opposite to the toner is applied to the intermediate transcriptional roller 20 as well, the cleaning bias has to be higher than the bias applied to the intermediate transcriptional roller 20.

The residual toner can be removed by the cleaning roller 50 due to the same effect as the mechanical “squeeze effect” by the fourth blade 41 described with reference to FIG. 4 and the attractive force that electrostatically attracts the residual toner by the cleaning bias. Since the squeeze effect by the cleaning roller 50 is the same as that by the fourth blade 41, an explanation thereon will be omitted.

In the second embodiment according to the present invention, the residual toner is electrostatically attracted due to the cleaning bias applied to the cleaning roller 50. The residual toner is transferred to the cleaning roller 50 from the surface of the intermediate transcriptional roller 20 due to the cleaning bias. At that time, the residual toner moves in the carrier solution (when the carrier solution does not exist between the cleaning roller 50 and the intermediate transcriptional roller 20, even though the cleaning bias is applied to the cleaning roller 50, the residual toner can hardly move without being in contact with the cleaning roller 50). The residual toner that has been transferred to a side of the cleaning roller 50 is thereafter scraped by a blade 41′.

It is noted that the cleaning roller 50 may be rotated in a clockwise direction or in a counterclockwise direction in FIG. 5. When the cleaning roller 50 is rotated in the counterclockwise direction, which is a forward direction with respect to the intermediate transcriptional roller 20 rotated in the clockwise direction, the cleaning operation can be performed without giving a load to the intermediate transcriptional roller 20. Meanwhile, when the cleaning roller 50 is rotated in the clockwise direction, the squeeze effect for the intermediate transcriptional roller 20 rotated in the same direction can be somewhat improved, yet a rotational load is applied to the intermediate transcriptional roller 20. Anyway, regardless of the rotational direction of the cleaning roller 50, a certain degree of effect of removing the residual toner can be attained.

FIG. 6 is a drawing for explaining a third embodiment according to the present invention. A wet electrophotographic apparatus in the third embodiment is configured with the carrier applying roll 42 in the first embodiment shown in FIG. 1 being replaced with a carrier applying roll 42′. The carrier applying roll 42′ has both functions of the carrier applying roll 42 and the cleaning roller 50 shown in FIG. 5. Namely, the carrier applying roll 42′ can apply the cleaning bias while performing the cleaning operation. Accordingly, since the residual toner is attracted in a position of the carrier applying roll 42′, the effect of removing the toner by the fourth blade 41 can be improved.

It is noted that the wet electrophotographic apparatus may be configured with the carrier applying roll 42 in the second embodiment shown in FIG. 5 being replaced with the carrier applying roll 42′ shown in FIG. 6. In this case, the effect of removing the toner by the cleaning roller 50 in the second embodiment can be improved.

The present disclosure relates to the subject matter contained in Japanese Patent Application No. P2006-025204, filed on Feb. 2, 2006, which is expressly incorporated herein by reference in its entirety.

What is claimed is:

1. A wet electrophotographic apparatus, comprising:
an intermediate transcriptional unit that includes a rubber member on a surface thereof, the intermediate transcriptional unit being configured to transcribe a toner image formed by toner held on a surface of the rubber member onto a printed subject;
a cleaning solution applying unit configured to apply cleaning solution to the surface of the rubber member after transcribing the toner image onto the printed subject; and
a toner removing unit configured to have a higher stiffness than that of the rubber member and to be in contact with the rubber member under a predetermined pressure so as to remove residual toner, which is left on the intermediate transcriptional unit even after transcribing the toner image onto the printed subject, with the cleaning solution.

2. The wet electrophotographic apparatus according claim 1,
wherein the toner removing unit is formed from rubber with a rubber hardness of 60° to 80°.

3. The wet electrophotographic apparatus according to claim 1,
wherein the rubber member included in the intermediate transcriptional unit is configured to have a JIS K6253 hardness of 20 to 60.

4. The wet electrophotographic apparatus according to claim 1,
wherein the rubber member included in the intermediate transcriptional unit is configured to have a surface roughness of 1 μm to 5 μm in a value of ten-point height of irregularities.

5. The wet electrophotographic apparatus according to claim 1,
wherein the toner removing unit is configured as a plate blade that mechanically scrapes the residual toner away from the intermediate transcriptional unit.

6. The wet electrophotographic apparatus according to claim 1,
wherein the toner removing unit is configured as a cleaning roller, to which a predetermined bias voltage with a polarity opposite to the toner is applied, so as to mechanically scrape and electrostatically attract the residual toner away from the intermediate transcriptional unit.

7. The wet electrophotographic apparatus according to claim 6,
wherein a bias voltage higher than that applied to the intermediate transcriptional unit is applied to the toner removing unit.

8. The wet electrophotographic apparatus according to claim 1,
wherein the cleaning solution applying unit is provided with a function of a cleaning roller, to which a predetermined bias voltage with a polarity opposite to the toner is applied, so as to mechanically scrape and electrostatically attract the residual toner away from the intermediate transcriptional unit.

9. The wet electrophotographic apparatus according to claim 8,
wherein a bias voltage higher than that applied to the intermediate transcriptional unit is applied to the cleaning solution applying unit.

10. The wet electrophotographic apparatus according to claim 1,
wherein the cleaning solution is carrier solution for conveying the toner.

11. The wet electrophotographic apparatus according to claim 1, further includes a cleaning solution supplying unit configured to supply carrier solution for conveying the toner as the cleaning solution to the cleaning solution applying unit.

12. The wet electrophotographic apparatus according to claim 11,
wherein the cleaning solution applying unit is shaped as a roller that is configured to be rotated around a rotational axis thereof, and
wherein the cleaning solution supplying unit includes a cleaning solution conveying mechanism that is configured to be helical and rotated around a rotational axis parallel to the rotational axis of the cleaning solution applying unit so that the cleaning solution can be conveyed along the rotational axis of the cleaning solution applying unit accompanying rotation of the cleaning solution conveying mechanism.

13. The wet electrophotographic apparatus according to claim 1, further includes a cleaning solution supplying unit configured to supply waste liquid, ejected from the wet electrophotographic apparatus, which includes carrier solution for conveying the toner, as the cleaning solution to the cleaning solution applying unit.

14. The wet electrophotographic apparatus according to claim 13, further includes a photoconductive drum configured to transcribe the toner image onto the intermediate transcriptional unit,
wherein the cleaning solution supplying unit is configured to supply waste liquid, ejected from the photoconductive drum after transcribing the toner image onto the intermediate transcriptional unit, as the cleaning solution to the cleaning solution applying unit.

15. The wet electrophotographic apparatus according to claim 13,
wherein the cleaning solution applying unit is shaped as a roller that is configured to be rotated around a rotational axis thereof, and
wherein the cleaning solution supplying unit includes a cleaning solution conveying mechanism that is configured to be helical and rotated around a rotational axis parallel to the rotational axis of the cleaning solution applying unit so that the cleaning solution can be conveyed along the rotational axis of the cleaning solution applying unit accompanying rotation of the cleaning solution conveying mechanism.

16. A wet electrophotographic apparatus, comprising:
a photoconductive drum configured to electrostatically attract toner onto an electrostatic latent image formed thereon so as to form a toner image corresponding to the latent image;
an intermediate transcriptional unit that includes a rubber member on a surface thereof, the toner image being transcribed onto a surface of the rubber member of the intermediate transcriptional unit, the intermediate transcriptional unit being configured to transcribe the toner image on the surface of the rubber member onto a printed subject;
a cleaning solution applying unit configured to apply cleaning solution to the surface of the rubber member after transcribing the toner image onto the printed subject;
a cleaning solution supplying unit configured to supply waste liquid including carrier solution for conveying the toner, which has been ejected from the photoconductive drum after transcribing the toner image onto the intermediate transcriptional unit, as the cleaning solution to the cleaning solution applying unit; and
a toner removing unit configured to have a higher stiffness than that of the rubber member and to be in contact with the rubber member under a predetermined pressure so as to remove residual toner, which is left on the intermediate transcriptional unit even after transcribing the toner image onto the printed subject, with the cleaning solution.

17. The wet electrophotographic apparatus according to claim 16,
wherein a predetermined bias voltage with a polarity opposite to the toner is applied to the toner removing unit so that the toner removing unit can electrostatically attract the residual toner left on the intermediate transcriptional unit.
